(19) United States
(12) Patent Application Publication
(10) Pub. No.: US 2016/0306766 A1
(43) Pub. Date: Oct. 20, 2016

(54) CONTROLLER AREA NETWORK BUS

(71) Applicant: AutoConnect Holdings LLC, Wellesley, MA (US)

(72) Inventor: Christopher P. Ricci, Saratoga, CA (US)

(21) Appl. No.: 15/073,955

(22) Filed: Mar. 18, 2016

Related U.S. Application Data
(63) Continuation of application No. 13/840,240, filed on Mar. 15, 2013, now abandoned.
(60) Provisional application No. 61/560,509, filed on Nov. 16, 2011.
(60) Provisional application No. 61/637,164, filed on Apr. 23, 2012.
(60) Provisional application No. 61/646,747, filed on May 14, 2012.
(60) Provisional application No. 61/653,275, filed on May 30, 2012.
(60) Provisional application No. 61/653,264, filed on May 30, 2012.
(60) Provisional application No. 61/653,563, filed on May 31, 2012.
(60) Provisional application No. 61/663,335, filed on Jun. 22, 2012.
(60) Provisional application No. 61/672,483, filed on Jul. 17, 2012.
(60) Provisional application No. 61/714,016, filed on Oct. 15, 2012.
(60) Provisional application No. 61/715,699, filed on Oct. 18, 2012.

(51) Int. Cl. G06F 13/40; G06F 13/42

(52) U.S. Cl. CPC G06F 13/4027; G06F 13/4221

(57) ABSTRACT

The present disclosure describes a vehicle implementing a processing module for receiving data from a high-speed CAN bus and sending data to a low-speed CAN bus. The processing module shunts into the data from the high-speed CAN bus without affecting the self-contained data flow of the high-speed CAN bus. The processing module analyzes the received data and generates data (by forwarding or other means) to be sent to a low-speed CAN bus according to the received data. The processing module is designed to be replaceable and/or upgradable without affecting other components during the life-cycle of the vehicle. The processing module may further contain expansion modules that perform tasks in response to the received data.

### CROSS REFERENCE TO RELATED APPLICATION

The present application is a continuation of and claims priority to U.S. patent application Ser. No. 13/840,240, filed Mar. 15, 2013, of the same title, which claims the benefits of and priority, under 35 U.S.C. §119(e), to U.S. Provisional Application Ser. No. 61/560,509, filed Nov. 16, 2011, entitled “Complete Vehicle Ecosystem”; 61/637,164, filed Apr. 23, 2012, entitled “Complete Vehicle Ecosystem”; 61/646,747, filed on May 14, 2012, entitled “Branding of Electrically Propelled Vehicles Via the Generation of Specific Operating Sounds”; 61/653,275, filed on May 30, 2012, entitled “Vehicle Application Store for Console”; 61/653,264, filed on May 30, 2012, entitled “Control of Device Features Based on Vehicle State”; 61/653,563, filed on May 31, 2012, entitled “Complete Vehicle Ecosystem”; 61/663,335, filed on Jun. 22, 2012, entitled “Complete Vehicle Ecosystem”; 61/672,483, filed on Jul. 17, 2012, entitled “Vehicle Climate Control”; 61/714,016, filed on Oct. 15, 2012, entitled “Vehicle Middleware”; and 61/715,699, filed Oct. 18, 2012, entitled Vehicle Middleware.” The entire disclosures of the applications listed above are hereby incorporated by reference, in their entirety, for all that they teach and for all purposes.

This application is also related to U.S. patent application Ser. No. 13/420,236, filed on Mar. 14, 2012 entitled “Configurable Vehicle Console”; Ser. No. 13/420,240, filed on Mar. 14, 2012 entitled “Removable, Configurable Vehicle Console”; Ser. No. 13/462,593, filed on May 2, 2012 entitled “Configurable Dash Display”; Ser. No. 13/462,596, filed on May 2, 2012 entitled “Configurable Heads-Up Dash Display”; Ser. No. 13/679,459, filed on Nov. 16, 2012 entitled “Vehicle Comprising Multi-Operating System” (Attorney Docket No. 6583-228); Ser. No. 13/679,234, filed on Nov. 16, 2012 entitled “Gesture Recognition for On-Board Display” (Attorney Docket No. 6583-229); Ser. No. 13/679,412, filed on Nov. 16, 2012 entitled “Vehicle Application Store for Console” (Attorney Docket No. 6583-230); Ser. No. 13/679,857, filed on Nov. 16, 2012 entitled “Sharing Applications/Media Between Car and Phone (Hydroid) (Attorney Docket 6583-231)”; Ser. No. 13/679,878, filed on Nov. 16, 2012 entitled “In-Cloud Connection for Car Multimedia” (Attorney Docket 6583-232); Ser. No. 13/679,875, filed on Nov. 16, 2012 entitled “Music Streaming” (Attorney Docket 6583-233); Ser. No. 13/679,676, filed on Nov. 16, 2012 entitled “Control of Device Features Based on Vehicle State” (Attorney Docket 6583-234); Ser. No. 13/678,673, filed on Nov. 16, 2012 entitled “Insurance Tracking” (Attorney Docket 6583-235); Ser. No. 13/678,691, filed on Nov. 16, 2012 entitled “Law Breaking/Behavior Sensor” (Attorney Docket 6583-236); Ser. No. 13/678,699 filed on Nov. 16, 2012 entitled “Etiquette Suggestion” (Attorney Docket 6583-237); Ser. No. 13/678,710, filed on Nov. 16, 2012 entitled “Parking Space Finder Based on Parking Meter Data” (Attorney Docket 6583-238; 13/678,722, filed on Nov. 16, 2012 entitled “Parking Meter Expired Alert” (Attorney Docket 6583-239); Ser. No. 13/678,726, filed on Nov. 16, 2012 entitled “Object Sensing (Pedestrian Avoidance/Accident Avoidance)” (Attorney Docket 6583-240); Ser. No. 13/678,735, filed on Nov. 16, 2012 entitled “Proximity Warning Relative to Other Cars” (Attorney Docket 6583-241); Ser. No. 13/678,745, filed on Nov. 16, 2012 entitled “Street Side Sensors” (Attorney Docket 6583-242; Ser. No. 13/678,753, filed on Nov. 16, 2012 entitled “Car Location” (Attorney Docket 6583-243; Ser. No. 13/679,441, filed on Nov. 16, 2012 entitled “Universal Bus in the Car” (Attorney Docket 6583-244); Ser. No. 13/679,864, filed on Nov. 16, 2012 entitled “Mobile Hot Spot/Router/Application Share Site or Network” (Attorney Docket 6583-245; Ser. No. 13/679,815, filed on Nov. 16, 2012 entitled “Universal Console Chassis for the Car” (Attorney Docket 6583-246; Ser. No. 13/679,476, filed on Nov. 16, 2012 entitled “Vehicle Middleware” (Attorney Docket 6583-247); Ser. No. 13/679,306, filed on Nov. 16, 2012 entitled “Method and System for Vehicle Data Collection Regarding Traffic” (Attorney Docket 6583-248; Ser. No. 13/679,369, filed on Nov. 16, 2012 entitled “Method and System for Vehicle Data Collection” (Attorney Docket 6583-249); Ser. No. 13/679,680, filed on Nov. 16, 2012, entitled “Communications Based on Vehicle Diagnostics and Indications” (Attorney Docket 6583-250); Ser. No. 13/679,443, filed on Nov. 16, 2012, entitled “Method and System for Maintaining and Reporting Vehicle Occupant Information” (Attorney Docket 6583-251); Ser. No. 13/678,762, filed on Nov. 16, 2012 entitled “Behavioral Tracking and Vehicle Applications” (Attorney Docket 6583-252); Ser. No. 13/679,292, filed Nov. 16, 2012, entitled “Branding of Electrically Propelled Vehicles Via the Generation of Specific Operating Output” (Attorney Docket 6583-258; 13/679,400, filed Nov. 16, 2012, entitled “Vehicle Climate Control” (Attorney Docket 6583-313); Ser. No. 13/678,773, filed on Nov. 16, 2012 entitled “Location Information Exchange Between Vehicle and Device” (Attorney Docket 6583-315; Ser. No. 13/679,887, filed on Nov. 16, 2012, entitled “In Car Communication Between Devices” (Attorney Docket 6583-316; Ser. No. 13/679,842, filed on Nov. 16, 2012 entitled “Configurable Hardware Unit for Car Systems” (Attorney Docket 6583-317); Ser. No. 13/679,204, filed on Nov. 16, 2012 entitled “Feature Recognition for Configuring a Vehicle Console and Associated Devices (Attorney Docket 6583-318)”; Ser. No. 13/679,350, filed on Nov. 16, 2012 entitled “Configurable Vehicle Console” (Attorney Docket 6583-412); Ser. No. 13/679,358, filed on Nov. 16, 2012 entitled “Configurable Dash Display” (Attorney Docket 6583-413); Ser. No. 13/679,363, filed on Nov. 16, 2012 entitled “Configurable Heads-Up Dash Display” (Attorney Docket 6583-414); and Ser. No. 13/679,368, filed on Nov. 16, 2012 entitled “Removable, Configurable Vehicle Console” (Attorney Docket 6583-415). The entire disclosures of the applications listed above are hereby incorporated by reference, in their entirety, for all that they teach and for all purposes.

### FIELD

The disclosure relates generally to vehicle bus systems and particularly to CAN Bus networks in a vehicle.

### BACKGROUND

Modern vehicles use a number of communication systems and/or networks. Each of these communication systems and/or networks may have a bus structure that is open or proprietary. Each of these buses may also be specifically designed to work in a vehicle or may be available as a general communication protocol. These communication systems and/or networks connect the various individual components of the vehicles through their respective buses. Examples of proprietary vehicle bus architecture include Controller Area Network (CAN) Bus, Local Interconnect Network (LIN) Bus, and the various Original Equipment Manufacturer (OEM) Bus among others. Examples of open and general bus architecture include wired or wireless Ethernet and Low-Voltage Differential Signaling (LVDS) among others.

Taking the CAN bus for example, the CAN bus is a serial network developed primarily for use with automotive applications. CAN bus allows devices and microcontrollers in a vehicle to communicate with each other without a host computer.

The CAN protocol allows various devices and microcontrollers to be connected to a single CAN bus. According to the protocol, communication along the CAN bus is message-based to allow messages and data to be sent from one connected device to another.

To facilitate communication on the CAN bus without the need of a host computer, CAN features an arbitration-free transmission mechanism. A CAN transmission includes an arbitration field (message ID) representing the priority of the message being transmitted. A dominant bit (‘0’) indicates a higher priority than a recessive bit (‘1’). For example, in a hypothetical two-bit ID CAN network, a device sending a ‘10’ ID will have priority over a device sending a ‘11’ ID on the CAN bus. In this example, both devices have a recessive bit in the first bit; however, the first device has a dominant second bit which could be used to arbitrate against a recessive second bit in the second device. The second device will back-off from transmitting over the bus upon this determination in favor of the second device and will attempt to retransmit a few clock cycles after the first device has finished transmitting. It is recognized that each message ID transmitted must be unique over the CAN bus for this arbitration-free transmission mechanism. According to the CAN specification, standard CAN (version 2.0A) uses 11-bit IDs, and extended CAN (version 2.0B) uses 29-bit IDs.

The CAN specification (ISO 11898) further describes two types of CAN buses, the high-speed CAN bus (ISO 11898-2) (such as for engine, suspension, and transmission controllers and safety equipment) and the low-speed CAN bus (ISO 11898-3) (such as for less critical components including non-safety sensors). The high-speed CAN bus is designed to carry data at high speed (up to 1 Mbit/s in some implementation). The low-speed CAN bus is designed to carry data at a lower speed (up to 125 Kbit/s in some implementation) but is more fault tolerant than the high-speed CAN bus. Further, the low-speed CAN bus can serve as a back-up for the high-speed CAN bus in case there is a failure to the high-speed CAN bus. The CAN specification as described in ISO 11898-1, 11898-2, 11898-3, 11898-4, 11898-5 and 11898-6 is herein incorporated by reference.

As usage of the CAN standard evolves, many vehicles and systems implementing CAN are using both a high-speed and a low-speed CAN bus in parallel. The high-speed CAN bus carries information that is vital for vehicle operation or safety and is delivered to various parts of the vehicle or system in substantially real time. For example, the high-speed CAN bus would be used in a situation where an airbag deploys. When sensors in the bumper or at the front of the vehicle indicate that the vehicle has been involved in a frontal collision, the sensors can send priority information via the high-speed CAN bus to the airbag deployment unit to deploy the airbag. The low-speed CAN bus would be used for other less critical applications.

A number of extensions have been proposed and used to extend the capabilities of the various bus architectures. For example, On-Board Diagnostics (OBD) adds support for requesting data from vehicle components for diagnostic purposes using Parameter Identifiers (PIDs). While OBD is designed to work with CAN bus, OBD can be implemented to work with other general and/or OEM specific buses. Further, specific vehicle components such as the Engine Control Unit (ECU), Transmission Control Unit (TCU), Anti-lock Braking System (ABS), and generally Body Control Modules (BCMs) can have specific protocol extensions to work with the various bus architectures. Further, extensions to the bus architectures are needed to support carrying information regarding various environmental type issues such as emissions information to comply with various government regulation mandates.

Vehicles, particularly passenger vehicles, are evolving rapidly with emerging safety, entertainment, and communication technologies. Existing vehicle bus protocols, which are largely designed for safety, are generally unsuitable for other non-safety communications, due to low bus bandwidth and transmission speed. There are therefore various needs in the art including improving information flow between vehicle components, leveraging the various communication systems and/or networks in the art to enhance vehicle safety, data security, and/or data processing, and providing remote authorized third party (i.e. peace officers, vehicle manufacturers, vehicle security services, and owners) access to a vehicle's functions and state information while maintaining security against unauthorized parties and components.

### SUMMARY

These and other needs are addressed by the various aspects, embodiments, and/or configurations of the present disclosure. The present disclosure is directed to a vehicle having a variety of networking and other capabilities.

The vehicle can include a processing module. The processing module includes a first bus interface configured for receiving data from a first bus and a second bus interface configured for sending data to a second bus. The processing module analyzes data received from the first bus and generates data to be sent through the second bus in response to the data received from the first bus. The first bus interface is also configured for listening to data from the first bus without affecting data flow in the first bus. The data to be sent through the second bus is priority data. The first bus may be a high-speed CAN bus and the second bus may be a low-speed CAN bus. The processing module is upgradable during the life-cycle of the vehicle.

A method of processing data in a plurality of vehicle buses includes receiving data from a first bus, analyzing the received data to determine relevance of the received data, generating data to be sent to a second bus, and sending the generated data over the second bus as priority data. The method may further include generating a task for an expansion module based on the received data from the first bus and according to pre-defined instructions, and sending the task to the expansion module. The method may still further include receiving feedback from the expansion module after sending the task.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “automotive navigation system” as used herein, can refer to a satellite navigation system designed for use in automobiles. It typically uses a GPS navigation device to acquire position data to locate the user on a road in the unit's map database. Using the road database, the unit can give directions to other locations along roads also in its database. Dead reckoning using distance data from sensors attached to the drivetrain, a gyroscope and an accelerometer can be used for greater reliability, as GPS signal loss and/or multipath can occur due to urban canyons or tunnels.

The term “bus” and variations thereof, as used herein, can refer to a subsystem that transfers information and/or data between various components. A bus generally refers to the collection communication hardware interface, interconnects, bus architecture, and/or protocol defining the communication scheme for a communication system and/or communication network. A bus may also specifically refer to a part of a communication hardware that interfaces the communication hardware with the interconnects that connect to other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

The terms “communication device,” “smartphone,” and “mobile device,” and variations thereof, as used herein, are used interchangeably and include any type of device capable of communicating with one or more of another device and/or across a communications network, via a communications protocol, and the like. Exemplary communication devices may include but are not limited to smartphones, handheld computers, laptops, netbooks, notebook computers, subnotebooks, tablet computers, scanners, portable gaming devices, phones, pagers, GPS modules, portable music players, and other Internet-enabled and/or network-connected devices.

The term “communication system” or “communication network” and variations thereof, as used herein, refers to a collection of communication components capable of one or more of transmission, relay, interconnect, control, or otherwise manipulate information or data from at least one transmitter to at least one receiver. As such, the communication may include a range of systems supporting point-to-point to broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include a wired and/or wireless network having a pre-set to an ad hoc network structure.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms “dash” and “dashboard” and variations thereof, as used herein, are used interchangeably and include any panel and/or area of a vehicle disposed adjacent to an operator, user, and/or passenger. Typical dashboards may include but are not limited to one or more control panel, instrument housing, head unit, indicator, gauge, meter, light, audio equipment, computer, screen, display, HUD unit, and graphical user interface.

The terms “determine,” “calculate” and “compute,” and variations thereof, as used herein, are used interchangeably and include any type of methodology, process, mathematical operation or technique.

The term “display” refers to a portion of a screen used to display the output of a computer to a user.

The term “displayed image” or “displayed object” refers to an image produced on the display. A typical displayed image is a window or desktop or portion thereof, such as an icon. The displayed image may occupy all or a portion of the display.

The term “electronic address” refers to any contactable address, including a telephone number, instant message handle, e-mail address, Universal Resource Locator (“URL”), Universal Resource Identifier (“URI”), Address of Record (“AOR”), electronic alias in a database, like addresses, and combinations thereof.

The terms “online community,” “e-community,” or “virtual community” mean a group of people that primarily interact via a computer network, rather than face to face, for social, professional, educational or other purposes. The interaction can use a variety of media formats, including wikis, blogs, chat rooms, Internet forums, instant messaging, email, and other forms of electronic media. Many media formats are used in social software separately or in combination, including text-based chatrooms and forums that use voice, video text or avatars.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

The term “presence” is a status indicator that conveys ability and willingness of a potential communication partner—for example a user—to communicate. A user's client provides presence information (presence state) via a network connection to a presence service, which is stored in what constitutes his personal availability record (called a presentity) and can be made available for distribution to other users (called watchers) to convey his availability for communication. Presence information has wide application in many communication services and is one of the innovations driving the popularity of instant messaging or recent implementations of voice over IP clients. A user client may publish a presence state to indicate its current communication status. This published state informs others that wish to contact the user of his availability and willingness to communicate. The most common use of presence today is to display an indicator icon on instant messaging clients, typically from a choice of graphic symbols with easy-to-convey meanings, and a list of corresponding text descriptions of each of the states. Even when technically not the same, the “on-hook” or “off-hook” state of a called telephone is an analogy, as long as the caller receives a distinctive tone indicating unavailability or availability.

The term “satellite positioning system receiver” refers to a wireless receiver or transceiver to receive and/or send location signals from and/or to a satellite positioning system, such as the Global Positioning System (“GPS”) (US), GLONASS (Russia), Galileo Positioning System (EU), Compass Navigation System (China), and Regional Navigational Satellite System (India).

The term “social network service” is a service provider that builds online communities of people, who share interests and/or activities, or who are interested in exploring the interests and activities of others. Most social network services are web-based and provide a variety of ways for users to interact, such as e-mail and instant messaging services.

The term “social network” refers to a web-based social network.

The term “screen,” “touch screen,” or “touchscreen” refers to a physical structure that enables the user to interact with the computer by touching areas on the screen and provides information to a user through a display. The touch screen may sense user contact in a number of different ways, such as by a change in an electrical parameter (e.g., resistance or capacitance), acoustic wave variations, infrared radiation proximity detection, light variation detection, and the like. In a resistive touch screen, for example, normally separated conductive and resistive metallic layers in the screen pass an electrical current. When a user touches the screen, the two layers make contact in the contacted location, whereby a change in electrical field is noted and the coordinates of the contacted location calculated. In a capacitive touch screen, a capacitive layer stores electrical charge, which is discharged to the user upon contact with the touch screen, causing a decrease in the charge of the capacitive layer. The decrease is measured, and the contacted location coordinates determined. In a surface acoustic wave touch screen, an acoustic wave is transmitted through the screen, and the acoustic wave is disturbed by user contact. A receiving transducer detects the user contact instance and determines the contacted location coordinates. The touch screen may or may not include a proximity sensor to sense a nearness of object, such as a user digit, to the screen.

The term “vehicle” refers to a device or structure for transporting animate and/or inanimate or tangible objects (e.g., persons and/or things), such as a self-propelled conveyance. The term “vehicle” as used herein includes any conveyance, or model of a conveyance, where the conveyance was originally designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, aircraft, space craft, flying machines, human-powered conveyances, and the like.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 depicts a vehicle configured in accordance with an embodiment;

FIG. 2 is a block diagram of a processing module according to an embodiment;

FIG. 3 depicts a flow diagram of a mode of processing according to an embodiment;

FIG. 4 depicts a flow diagram of a mode of processing according to an embodiment; and

FIG. 5 depicts a vehicle with multiple processing modules according to an embodiment.

### DETAILED DESCRIPTION

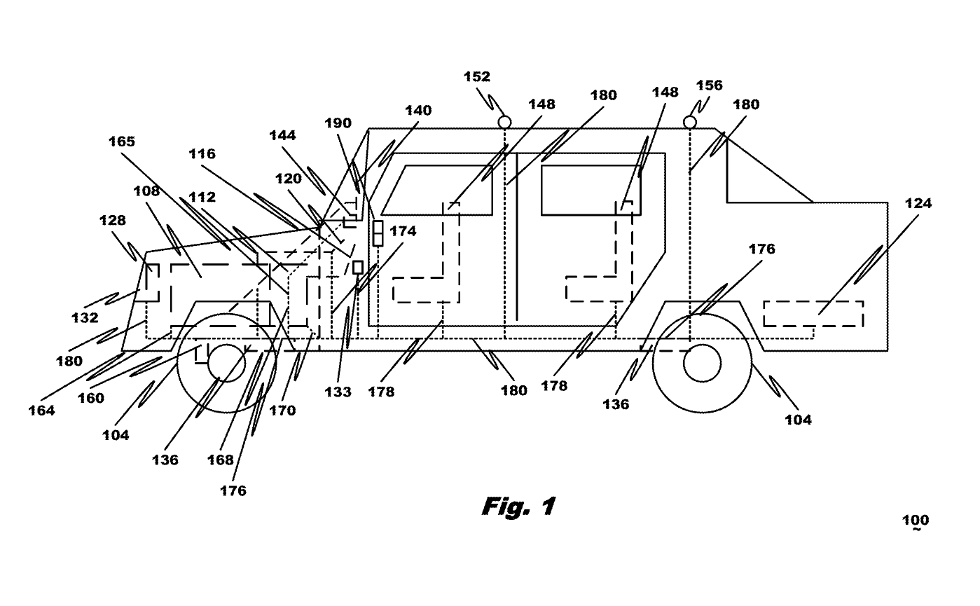

Referring to FIG. 1, the vehicle 100 includes, among many components common to vehicles, wheels 104, a power source 108 (such as an engine, motor, or energy storage system (e.g., battery or capacitive energy storage system)), a manual or automatic transmission 112, a manual or automatic transmission gear controller 116, a power controller 120 (such as a throttle), a braking system 136, a steering wheel 140, a display panel 144 (e.g., a dashboard displaying information regarding components in vehicle 100), and an occupant seating system 148.

Other components in vehicle 100 include communication components such as a wireless signal receiver 152 to receive wireless signals from signal sources such as roadside beacons and other electronic roadside devices, and a satellite positioning system receiver 156 (e.g., a Global Positioning System (“GPS”) (US), GLONASS (Russia), Galileo Positioning System (EU), Compass Navigation System (China), and Regional Navigational Satellite System (India) receiver).

The vehicle 100 also includes a number of control units and sensors for the various components of vehicle 100. Exemplary control units and sensors therefor include wheel state sensor 160 to sense one or more of vehicle speed, acceleration, deceleration, wheel rotation, wheel speed (e.g., wheel revolutions-per-minute), wheel slip, and the like. Power source controller and energy output sensor 164 controls the power source and senses a power output of the power source 108. Example aspects of power source controller and energy output sensor 165 include balancing the mixture of fuel (e.g., gasoline, natural gas, or other sources of fuel) and other elements (e.g., air for combustion) and measuring one or more of current engine speed (e.g., revolutions-per-minute), energy input and/or output (e.g., voltage, current, fuel consumption, and torque), and the like. Switch state control unit 168 activates or deactivates the power source (e.g., the ignition). Transmission Control Unit (“TCU”) 170 sets the current state the transmission (e.g., gear selection or setting) based on the state of gear controller 116. Power control unit 174 sets the throttle for power source 108 given the state of power controller 120. Brake control unit 176 operates the current state (braking or non-braking) of braking system 136 based on the state of the brake controller (which could be linked to power controller 120).

Vehicle 100 also includes other control units and sensors for safety purposes. An airbag deployment system includes an airbag deployment control unit 133 and a collision sensor 132. When a collision is detected by collision sensor 132, data is sent to airbag deployment control unit 133 which determines whether to deploy the airbag based on the data received (e.g., the speed of the collision and the area of impact to determine whether an airbag deployment can promote safety). Other safety components include seat belt control unit and sensors for setting the seat belt (e.g., engaging or disengaging the seat belt during hard breaking), headlight control unit and sensors for headlight 128 and other lights (e.g., emergency light, brake light, parking light, fog light, interior or passenger compartment light, and/or tail light state (on or off)), door settings (locking and unlocking), window settings (opening or closing), one or more cameras or other imaging sensors (which commonly convert an optical image into an electronic signal but may include other devices for detection objects such as an electromagnetic radiation emitter/receiver that emits electromagnetic radiation and receives electromagnetic waves reflected by the object) to sense objects, such as other vehicles and pedestrians and optionally determine the distance, trajectory and speed of such objects, in the vicinity or path of the vehicle, and other components and sensors as known in the art.

Vehicle 100 further includes components for the convenience and enjoyment of the occupants or operators. Seating system controller and sensor 178 sets the position and other settings of a seat and measure various attributes of an occupant of the seat (e.g., the current weight of seated occupant) in a selected seat of the seating system 148. Entertainment system 190, preferably located in the head unit of the passenger compartment, provides entertainment options such as music or video for occupants of vehicle 100.

Examples of other vehicle components include one or more cameras or other imaging sensors (which commonly convert an optical image into an electronic signal but may include other devices for detection objects such as an electromagnetic radiation emitter/receiver that emits electromagnetic radiation and receives electromagnetic waves reflected by the object) to sense objects, such as other vehicles and pedestrians and optionally determine the distance, trajectory and speed of such objects, in the vicinity or path of the vehicle, odometer reading sensor, trip mileage reading sensor, wind speed sensor, radar transmitter/receiver output, brake wear sensor, steering/torque sensor, oxygen sensor, ambient lighting sensor, vision system sensor, ranging sensor, parking sensor, heating, venting, and air conditioning (HVAC) sensor, water sensor, air-fuel ratio meter, blind spot monitor, hall effect sensor, microphone, radio frequency (RF) sensor, infrared (IR) sensor, vehicle control system sensors, wireless network sensor (e.g., Wi-Fi and/or Bluetooth sensor), cellular data sensor, and other sensors known to those of skill in the vehicle art.

Vehicle 100 includes one or more vehicle buses 180 for connecting the various components and systems of vehicle 100 as described above. In modern vehicles, subsystems such as an anti-lock braking system (ABS), which may be used by brake control unit 176 and braking system 136, engine control unit (ECU), which may be used by power source control 164, transmission control unit (TCU), which may be used by transmission control unit 170 and gear controller 116, and supplemental restraint system (SRS), such as airbag deployment control unit 133 and collision sensor 132 and seating system controller and sensor 178, are frequently interconnected using a standardized bus. Standardized buses for use in vehicles include Controller Area Network (CAN), Local Interconnect Network (LIN) and others, as are known in the art. In particular, these components and subsystems may use the high-speed CAN bus for real-time information. Other components with lower priorities may use the low-speed CAN bus to transmit information. Vehicle bus 180 (which is optional) is illustrated as one bus in FIG. 1. However, vehicle 100 may include one or more of these standardized buses, such as a combination of the high-speed and low-speed CAN, LIN, and/or other buses. Also, vehicle bus 180 may further include and support extensions to standardized buses, such as the FlexCAN extension to the CAN bus. Further, vehicle bus 180 may include standardized communication networks that can be implemented vehicle 100. Well known networks include Ethernet, Wi-Fi, USB, I²C, RS232, RS485 and FireWire.

Vehicle 100 also includes processing module 124. Preferably, processing module 124 is placed in the trunk, hood (not shown), behind the head unit (not shown), and/or other accessible but unseen locations. Processing module 124 is coupled to vehicle bus 180 and provides processing for data related to vehicle bus 180 and other vehicle components.

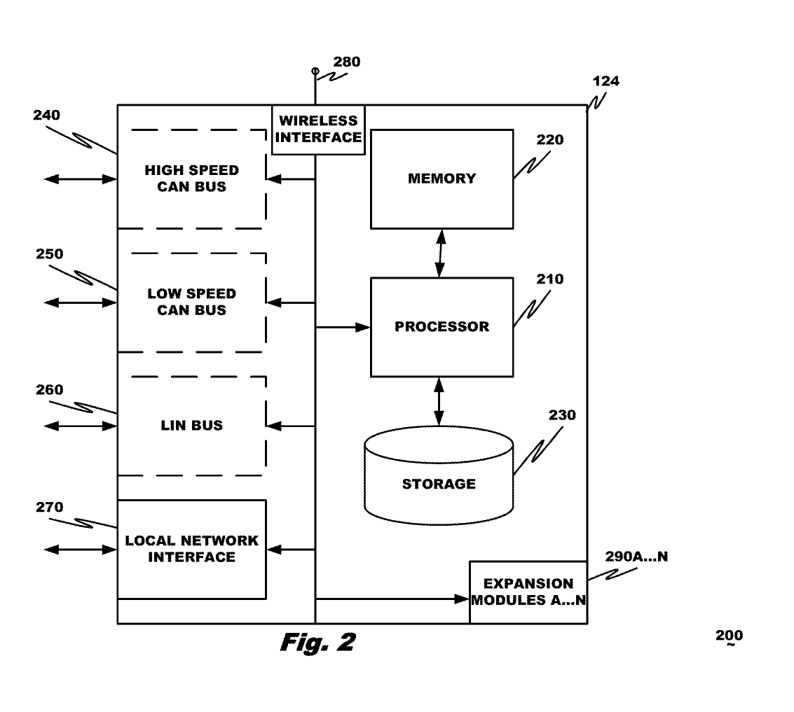

Processing modules, for example, can perform, monitor, and/or control critical and non-critical tasks, functions, and operations, such as interaction with and/or monitoring and/or control of critical and non-critical on board sensors and vehicle operations (e.g., engine, transmission, throttle, brake power assist/brake lock-up, electronic suspension, traction and stability control, parallel parking assistance, occupant protection systems, power steering assistance, self-diagnostics, event data recorders, steer-by-wire and/or brake-by-wire operations, vehicle-to-vehicle interactions, vehicle-to-infrastructure interactions, partial and/or full automation, telematics, navigation/SPS, multimedia systems, audio systems, rear seat entertainment systems, game consoles, tuners (SDR), heads-up display, night vision, lane departure warning, adaptive cruise control, adaptive headlights, collision warning, blind spot sensors, park/reverse assistance, tire pressure monitoring, traffic signal recognition, vehicle tracking (e.g., LoJack™) dashboard/instrument cluster, lights, seats, climate control, voice recognition, remote keyless entry, security alarm systems, and wiper/window control). Processing modules can be enclosed in an advanced EMI-shielded enclosure containing multiple expansion modules. Processing modules can have a “black box” or flight data recorder technology, containing an event (or driving history) recorder (containing operational information collected from vehicle on board sensors and provided by nearby or roadside signal transmitters), a crash survivable memory unit, an integrated controller and circuitry board, and network interfaces. Processing module 124 is further disclosed with reference to FIG. 2.

FIG. 2 illustrates an exemplary block diagram for a processing module 124.

Processing module 124 may include processor 210, memory 220, storage 230, and interfaces for one or more buses 240-270. Among the interfaces 240-270 include high-speed CAN bus 240, low-speed CAN bus 250, LIN bus 260, network interface 270, and/or wireless interface 280. One skilled in the art will recognize that processing module 124 may take other configurations and with other buses as known in the art, and interfaces 240-290 may be implemented with more or fewer buses than those shown. Processing module 124 may also include a number of expansion modules 290a-n.

The high-speed CAN bus 240 also called the power train bus as the high speed CAN bus may be connected with engine controllers 164, transmission controllers 170, other BCMs and other safety related vehicle components. The high speed CAN bus 240 can transmit data at 500 kb/s, which facilitates transmitting data in an accident event where connected components require reaction times of no more than a few microseconds (i.e., deploying an airbag when a collision is detected). Further, the high speed CAN bus is typically self-contained with no central processing unit and is only connected to the relevant vehicle components.

The low-speed CAN bus 250 can transmit data at 125 kb/s and may be connected with other non-critical components. The low speed CAN bus 250 may be connected to other non-critical BCMs and other modules.

Further, a number of vehicle components and modules may also be connected together by proprietary gateway modules depending on the Original Design Manufacturer (ODM). Vehicle components are also connected and accessible by an outside third party (i.e., repair technicians, police, end user) through a connection port and bus system in systems such as On-Board Diagnostics (OBD). OBD systems include Assembly Line Diagnostic Link (ALDL), OBD-I, OBD-1.5, OBD-II, European On Board Diagnostics (EOBD), EOBD2, Japanese On Board Diagnostics (JOBD), Australian Design Rule (ADR) 79/01, ADR 79/02, and others.

The processor 210 may comprise a general purpose programmable (micro)processor or controller for executing application programming or instructions. In accordance with at least some embodiments, the processor 210 may include multiple processor cores, and/or implement multiple virtual processors. In accordance with still other embodiments, the processor 210 may include multiple physical processors. As a particular example, the processor 304 may comprise a specially configured application specific integrated circuit (ASIC) or other integrated circuit, a digital signal processor, a controller, a hardwired electronic or logic circuit, a programmable logic device or gate array, a special purpose computer, or the like. The processor 210 generally functions to run programming code or instructions implementing various functions of the device 200.

Memory 220 for use in connection with the execution of application programming or instructions by the processor 210, and for the temporary or long term storage of program instructions and/or data. As examples, the memory 220 may comprise RAM, DRAM, SDRAM, or other solid state memory. Alternatively or in addition, data storage 230 may be provided. Like the memory 220, the data storage 230 may comprise a solid state memory device or devices. Alternatively or in addition, the data storage 230 may comprise a hard disk drive or other random access memory.

One feature of processing module 124 is that processing module 124 may be replaced and/or upgraded as a stand-alone module during the life of vehicle 100. For example, the Open Multimedia Applications Platform (OMAP) is a general purpose processor for portable and mobile applications which may be used in processing module 124. Processing module 124 may use the OMAP4 processor when the vehicle 100 is produced, but may be upgraded to a newer generation processor in later years but still during the life-cycle of vehicle 100 without affecting other components of vehicle 100.

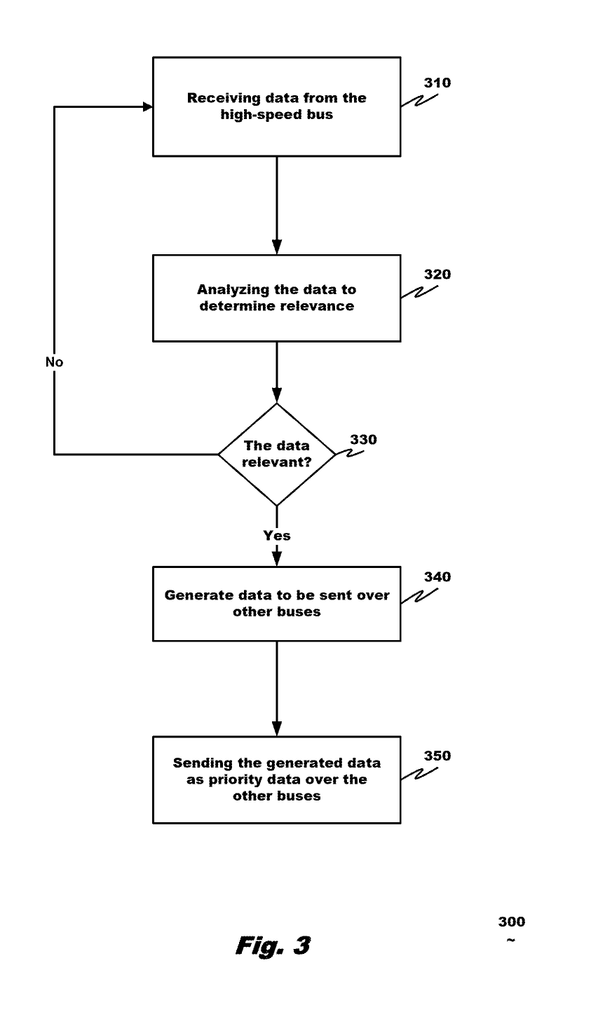

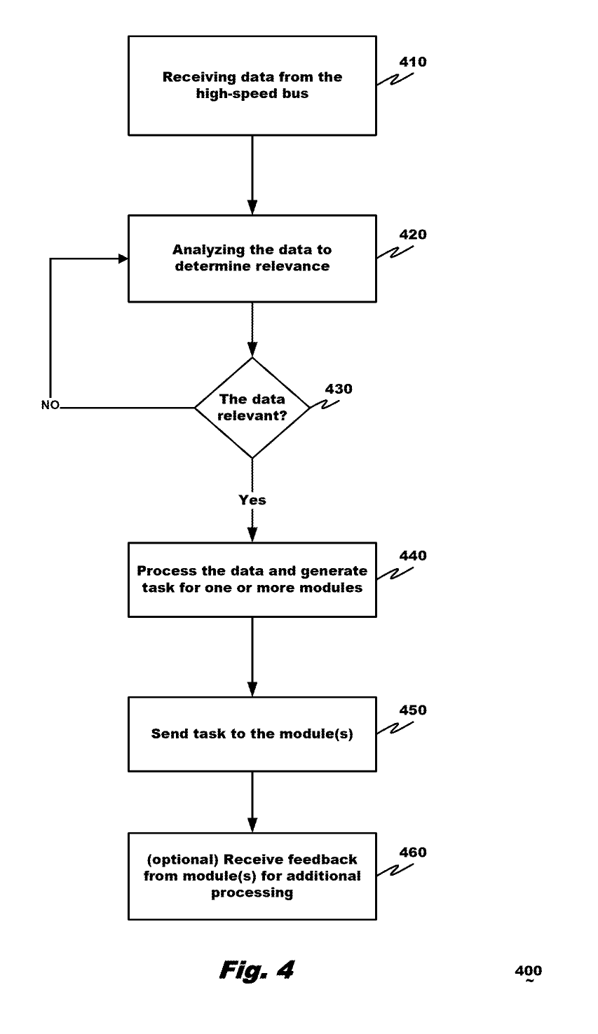

FIGS. 3 and 4 depict flow diagrams of modes of processing according to embodiments.

The operations of processing module 124 will now be described with respect to FIGS. 3 and 4. The high-speed CAN bus and low-speed CAN bus are described as exemplary configurations. However, other buses may be used as now known or can be later derived by one of ordinary skill in the art.

In the mode of processing as depicted in FIG. 3 according to an embodiment, processing module 124 receives data from the high-speed CAN bus 310.

In one implementation, processing module 124 is shunt into the data transmitted in the high-speed CAN bus through high-speed CAN bus interface 240 such that data flow within the high-speed CAN bus is unaffected by processing module 124. This implementation can be used to add processing module 124 to existing vehicles not originally designed with processing module 124. This implementation can also be used in vehicles designed with processing module 124 but with needs to maintain the data efficiency and integrity of the high-speed CAN bus. In one example, high-speed CAN bus interface 240 may contain two channels, one channel that streams data from the high-speed CAN bus while a second channel contains a repeater that duplicates the data for processing by processing module 124. This implementation ensures that data in the high-speed CAN bus is mostly unaffected by the addition of processing module 124 to the data path.

In another implementation, processing module 124 is placed as an integral part of the high-speed CAN bus system (i.e., as one critical BCM). This implementation requires changes in the design considerations to the other controllers and BCMs connected to the high-speed CAN bus to integrate processing module 124 with the other parts of the self-contained high-speed CAN bus system. This implementation has the benefit of robustness and flexibility in later modifications and/or expansions and other benefits now known or later realized.

Next, processing module 124 analyzes the received data from the high-speed CAN bus 320 to determine if the data is relevant for processing. As discussed previously, data transmitted over the high-speed CAN bus includes priority data from subsystems such as anti-lock braking system (ABS), which may be used by brake control unit 176 and braking system 136, engine control unit (ECU), which may be used by power source control 108, transmission control unit (TCU), which may be used by transmission control unit 170 and gear controller 116, and supplemental restraint system (SRS), such as airbag deployment control unit 133 and collision sensor 132 and seating system controller and sensor 178, as described above.

Because not all data transmitted over the high-speed CAN bus will be relevant to processing by processing module 124, step 320 analyzes and filters data that does not require processing. For example, certain periodic update or health-check data from the various components will not be processed by processing module 124 if processing module 124 does not need to log these data.

In one implementation of step 320, processing module 124 may compare received data with a list of events or tasks that the processing module 124 is defined to handle. The list may be stored (i.e., in storage 230) and may be updated or altered as needed. The list may include information about data that is handled by processing module 124 such as the component type, event or data type, and other information. The received data is analyzed and compared with the list to ensure that relevant data would be properly handled by processing module 124 while irrelevant data is not handled.

In some implementations, the list of events or tasks may be definable or modifiable by the user. For example, a user may periodically update the list as needed or when new components are added or updated to the vehicle or processing module 124. Further, the list may be updated to conform with changing conditions (such as new laws requiring certain vehicle configurations or when the vehicle is moved to another primary operational area). In one implementation, some user configurations to the list (e.g., turning off data related to deployment of an airbag) may be limited for safety or other reasons. These configurations may be made at an approved vehicle shop or dealership. A user may define or modify the list through software means such as configuring the list via a vehicle console (i.e., a console integrated with entertainment system 190) or a console directly connected to or accessible to processing module 124. A user may also define or modify the list through hardware means such as installing programming chips to processing module 124 in specialized slots or in an expansion module 290a-n.

In decision diamond 330, the process returns to listening and receiving data from the high-speed bus if the received data is not relevant. Otherwise, the processor module 124 processes generating data to be sent over the other buses (i.e., the low-speed CAN bus) 340.

In step 340, the processing module 124 generates data to be sent over the other buses that is responsive to the received data. In one implementation, in a simple case, processing module 124 may simply relay the received data to the other bus. In another implementation, processing module 124 may use one or more received data and perform further processing on the received data to generate the sent data. For example, in a case where a collision is detected and the airbag is to deploy, two signals are separately received for the collision detection by a detector and the airbag deployment by the airbag controller, respectively. Processing module 124 may receive the two separate data signals in succession and aggregate them before sending data to the other busses, perhaps for the purpose of ensuring that the non-critical components of the vehicle are safe and could perform power down procedures. Here, the processing module 124 generates custom data that is only used when the two data signals from the high-speed bus are received in succession.

Instructions on how to generate the sent data may be stored and retrieved (i.e., in storage 230). Further, the instructions may be organized in conjunction with the list on determining if the received data is relevant as discussed with respect to step 320 above. As discussed previously, data transmitted over the low-speed CAN bus includes other noncritical data, such as engine temperature and oil pressure sensor readings.

In one implementation, step 340 is also involved in translating the data received from high-speed CAN bus to data that is compatible to be sent over the low-speed CAN bus. As discussed previously, the high-speed CAN bus and the low-speed CAN bus operates at different data speeds, bandwidths, and interfaces with different vehicle components. Further, each CAN bus is designed to be independent and self-contained with regards to data transmission. Therefore, retransmitting data from the high-speed CAN bus to the low-speed CAN bus may require translating the received data to be sent (i.e., simplifying the data to conciliate speed and bandwidth requirements, reformatting the data to facilitate different target components, such as forwarding the data to a display output or to another processing component). In another implementation, the instructions on generating the sent data may also include instructions on the translation of data.

Finally, processing module 124 sends the generated data as priority data over the other buses 350. In step 350, processing module 124 sends the generated data based on the protocol for the bus that the data is to be sent over. For example, the low-speed CAN bus is a serial bus. The processing module 124 would interrupt data flow on the low-speed CAN bus in order to send the generated data as priority data.

Wireless interface 280, by contrast, can be a transceiver for one or more long, intermediate, or short range wireless networks, such as a radio (e.g., cellular such as CDMA, GSM, or IS-95 network), 802.X, a WiFi™ network, a Bluetooth™ network, and the like, sending and receiving a wide variety of information, including lower priority information, such as data for the convenience and enjoyment of the occupants in entertainment system 190 or seating system 148. The wireless interface 280 can access information over one or more wireless networks using an appropriate protocol, such as the Wireless Application Protocol, Wireless Internet Protocol, Wireless Session Protocol, Bluetooth Wireless Protocol, Wireless Datagram Protocol, Wireless HART protocol, Wired Equivalent Privacy (WEP), MiWi and MiWi P2P, RuBee (IEEE standard 1902.1), Wireless USB, Wireless Transport Layer Security (WTLS), and the like. In one vehicle configuration, the wireless interface 280 connects, via a short distance protocol such as Bluetooth™ or WiFi™, to an external computational device, such as a cell phone, personal digital assistant, laptop, personal computer, or tablet computer, for access to remote nodes over the Internet.

Local network interface 270 is a transceiver for signals exchanged with other on board components of the vehicle (including the components discussed above with respect to FIG. 1). The signals may be sent over a wired or wireless (or combination thereof) network. In one configuration, the local network interface is a wireless access point. Any suitable local area network protocol may be used, with the Ethernet protocol and the short-range protocols mentioned above being examples.

The processing module 124 would coordinate sending the generated data depending on the bus or network protocol. In the wireless interface 280 and local network interface 270, processing module 124 may queue the generated data to be sent in the transmission stack, where it can attempt to prioritize the generated data in the queue.

In the mode of processing as depicted in FIG. 4, processing module 124 receives data from the high-speed CAN bus 410, analyzes the received data to determine relevance 420, and decides if the received data is relevant 430 in a similar process as described with respect to FIG. 3.

If the received data is relevant, processing module 124 processes the received data and generates tasks for one or more modules 440. Expansion modules 290a-n are modules that a user may add to processing module 124 in order to expand the functionalities of processing module 124. For example, expansion module 290a may contain a wireless or cellular phone module, which may make emergency calls or calls to repair shops when a problem is detected in vehicle 100 given by the received data from the high-speed CAN bus.

One issue with expansion modules in a vehicle is that the OEMs may wish to prevent the integration of non-approved or after-market modules to mitigate the risks of non-compatible modules from affecting normal vehicle performance. Expansion modules 290a-n and processing module 124 may implement a validation process for newly installed modules and modules in continuing usage to verify approved modules.

Similar to the generating data to be sent over other buses 340 in FIG. 3, step 440 generates data to be sent over an expansion module 290a-n that is responsive to the received data. Further, processing module 124 may need to generate a task for the expansion module. For example, instructions are sent to a wireless or cellular module for a task to call emergency services and repair facilities if a vehicle is detected to be in an accident.

The processing module then sends the task to the module(s) similar to step 340 in FIG. 3.

Optionally, processing module 124 may receive feedback from the module(s) for additional processing. For example, an expansion module may send reports and updates on carrying out and completing its assigned tasks. Further, an expansion module may also send additional data to processing module 124. Processing module 124 may process the additional data using a similar process as with the high-speed CAN bus data.

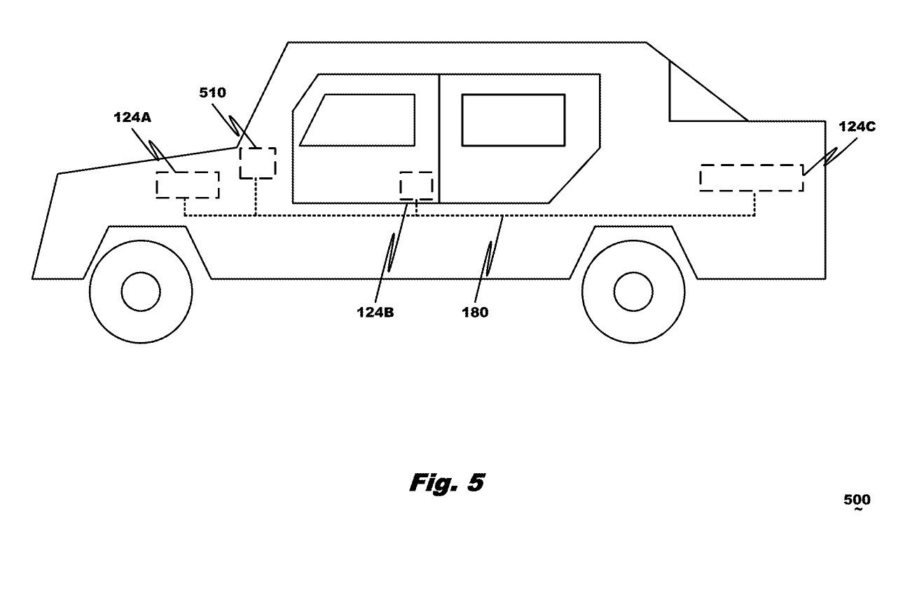

FIG. 5 depicts a vehicle 500 with multiple processing modules according to an embodiment. Vehicle 500 includes bus 180, vehicle component 510, and processing modules 124A-C.

Vehicle component 510 is an exemplary vehicle component for illustration purposes that is connected to bus 180. Vehicle component 510 may represent any of the vehicle components discussed in connection with vehicle 100 (FIG. 1).

Each of the processing modules 124A-C is each coupled to bus 180. Processing module 124A is located in the engine compartment of vehicle 500; processing module 124B is located in the passenger compartment of vehicle 500; and processing module 124C is located in the truck of vehicle 500.

In one configuration, some of the processing modules 124A-C may have limited processing functions as compared to the others. For example, processing module 124A may act as the default processing module for vehicle 500 because of its location being close to most critical vehicle components in the engine compartment (i.e., ECU, TCU). If the other processing modules 124B-C are only needed for redundancy, they may be implemented to only have limited capabilities (i.e., these processing modules would not be required to process all critical and non-critical functions). This implementation has the advantage of reduced costs and/or space as compared to fitting processing module will full capabilities. The processing modules 124A-C may also have cascading levels of capabilities. For example, processing module 124B is fitted in the passenger compartment and is deemed to most likely survive a collision; it may be required to have capabilities critical to vehicle operation but no other capabilities to save space in the passenger compartment. Processing module 124C may have additional capabilities such as a cellular module so that emergency calls may be automatically placed if the default processing module 124A fails.

In another configuration, each of the processing modules 124A-C may have different capabilities. For example, processing module 124A may have capabilities only for critical vehicle functions; processing module 124C may have capabilities only for non-critical vehicle functions; and processing module 124B may be reserved for back-up processing of both critical and non-critical vehicle functions. In one implementation, processing may be off-loaded to another processing module if one module becomes overloaded. This configuration has the advantage of further reduction in costs and space because processing power is not wasted due to redundancy. In the case where one processing module malfunctions, the other processing modules may pick up processing duties via a processor off-load procedure. If there is not enough processing power for all wanted functionalities, the processing modules may work together to prioritize critical vehicle functions ahead of non-critical functions.

As such, advantages of the embodiments include extensive and robust integration of vehicle components via existing vehicle buses. Further, the embodiments facilitate more efficient data transmission and bandwidth usage within the vehicle buses. Vehicle components are further modularized with added advantages of replaceable and upgradable parts, including the processing module, within the operational life of the vehicle. These and other advantages may be realized now or during the practice of the embodiments.

Furthermore, while the exemplary aspects, embodiments, and/or configurations illustrated herein show the various components of the system colocated, certain components of the system can be located remotely, at distant portions of a distributed network, such as a LAN and/or the Internet, or within a dedicated system. Thus, it should be appreciated, that the components of the system can be combined into one or more devices, such as a vehicle computer system, a Personal Computer (PC), laptop, netbook, smart phone, Personal Digital Assistant (PDA), tablet, etc., or colocated on a particular node of a distributed network, such as an analog and/or digital communications network, a packet-switch network, or a circuit-switched network or collocated on a particular node of a distributed network, such as an analog and/or digital communications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a server. Similarly, one or more functional portions of the system could be distributed between a communications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example, in one alternate embodiment, the application store is applied in a vehicle other than a wheeled or tracked vehicle. For example, the application store can be implemented in an aircraft, boat, ship, and the like.

In another alternative embodiment, the application store can include not only media player software but also media itself. Media, for example, can involve one or more media types (e.g., audio and/or video). Media can thus refer to music, movies, videos, audio books, pictures, screen savers, display wallpaper, and the like.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. For example, in the foregoing Detailed Description, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A processing module, associated with a vehicle, comprising:
a first bus interface in communication with a first vehicle component through a first CAN bus, wherein the first bus interface receives CAN protocol data from the first CAN bus;
a processor, in communication with the first bus interface, that:
receives the CAN protocol data from the first bus interface;
analyzes the CAN protocol data sent from the first bus interface;
generates second data from the CAN protocol data to be sent through a second bus; and
sends the second data to a second bus interface; and
the second bus interface in communication with a second vehicle component, through the second bus, and the processor, wherein the second bus interface:
receives the second data; and
sends the second data on the second bus.

2. (canceled)

3. The processing module of claim 1, wherein the first CAN bus is a high-speed CAN bus.

4. The processing module of claim 1, wherein the second bus is a low-speed CAN bus.

5. The processing module of claim 1, wherein the second bus is a LIN bus.

6. The processing module of claim 1, wherein the second bus is a network bus.

7. The processing module of claim 1, wherein the first bus interface is shunted into the first CAN bus and configured for listening to data from the first CAN bus without affecting data flow in the first bus.

8. The processing module of claim 1, wherein the second data to be sent through the second bus is sent as priority data.

9. The processing module of claim 1, the processing module further comprises one or more expansion modules, wherein the processing module generates tasks for the one or more expansion modules.

10. The processing module of claim 9, wherein the processing module receives feedback from the one or more expansion modules.

11. The processing module of claim 1, wherein the processing module is upgradable during the life-cycle of the vehicle.

12. A method of processing data through a plurality of vehicle buses of a vehicle, comprising:
receiving CAN protocol data transmitted by a first component through a first CAN bus;
analyzing the received CAN protocol data to determine relevance of the received CAN protocol data;
generating second data to be sent to a second component through a second bus; and
sending the generated data over the second bus as priority data.

13. The method of claim 12, wherein generating second data to be sent to the second bus comprises using the received CAN protocol data from the first CAN bus as the generated data.

14. The method of claim 12, wherein generating second data to be sent to the second bus comprises using and manipulating the received CAN protocol data according to pre-defined instructions to generate second data to be sent to the second bus.

15. The method of claim 12, further comprising:
generating a task for an expansion module based on the received CAN protocol data from the first CAN bus and according to pre-defined instructions; and
sending the task to the expansion module.

16. The method of claim 15, the method further comprises receiving feedback from the module after sending the task.

17. The method of claim 12, wherein the first CAN bus is a high-speed CAN bus.

18. The method of claim 12, wherein the second bus is a low-speed CAN bus.

19. The method of claim 12, wherein the first CAN bus is a self-contained bus having a self-contained data flow, and wherein receiving CAN protocol data from the first CAN bus maintains the self-contained data flow.

20. A processing module for a vehicle, comprising:
a first bus interface coupled to a first component in the vehicle through a first CAN bus;
a second bus interface coupled to a second component in the vehicle through a second bus; and
a processor configured to process instructions to analyze received CAN protocol data from the first component through the first bus and to generate second data to be sent to the second component through the second bus based on the received CAN protocol data from the first component as priority data.
